(19) United States
(12) Patent Application Publication
(10) Pub. No.: US 2025/0389060 A1
(43) Pub. Date: Dec. 25, 2025

(54) IMPROVED TEXTILE PROTECTIVE ELEMENT FOR USE IN ACOUSTIC COMPONENTS OF ELECTRONIC DEVICES AND ACOUSTIC COMPONENT PROVIDED WITH THIS ELEMENT INSIDE

(71) Applicant: SAATI S.P.A., Appiano Gentile (IT)

(72) Inventors: Marco MIETTA, Appiano Gentile (IT); Vasco MARELLI, Appiano Gentile (IT); Lorenzo GELSO, Appiano Gentile (IT); Carmine LUCIGNANO, Appiano Gentile (IT); Paolo CANONICO, Appiano Gentile (IT); Roberto MOMENTE, Appiano Gentile (IT); Sergio PESENTI, Appiano Gentile (IT)

(21) Appl. No.: 18/878,921

(22) PCT Filed: Jun. 28, 2023
(86) PCT No.: PCT/IB2023/056692

§ 371 Date: Dec. 26, 2024

(30) Foreign Application Priority Data
Jul. 6, 2022 (IT) 102022000014272
Nov. 8, 2022 (IT) 102022000023049

(51) Int. Cl. D03D 9/00; D03D 15/225; D03D 15/33

(52) U.S. Cl. CPC D03D 9/00; D03D 15/225; D03D 15/33; D10B 2201/24; D10B 2505/00

(57) ABSTRACT

Protective element for consumer electronic devices provided with at least one port (101) and one channel (105) for an acoustic component (104), wherein said port (101) or said channel (105) have a protection fabric against the intrusion of contaminating particles and sprays of water. According to the invention, said fabric (25) has meshes (11) having a rectangular shape, whose sides (12, 13) are made up by respective threads (26, 27). In comparison with the square mesh fabrics of the prior art, having comparable characteristics of air passage and sound transmission, the fabric forming the protective element of the invention offers the advantage of providing an increased protection capability from contaminating particles.

### BACKGROUND OF THE INVENTION

The present invention relates to a protective element made of a high-performance fabric, particularly suitable for use in acoustic components (typically micro-speakers) of consumer electronic devices (typically smartphones and tablets), in order to carry out the function of protection from particulate matter and sprays of water, together with an optimal sound transmission achieved thanks to its particular structure.

The electronic devices endowed with acoustic functions, such as the smartphones, are provided with small openings on their external shell, located at acoustic components such as speakers and microphones, through which the acoustic waves can be transmitted. However, these openings, required in almost all cases, involve the risk that some external contaminating particles could penetrate into the device and be harmful. This is true both for solid particles, which may accumulate on the speaker diaphragm and hinder its free movement, and for water drops resulting from sprays which in some cases may compromise the functionality of the electronic device. Therefore, there is the need of stopping these contaminants at the acoustic port of the device, without them entering inside it.

For such a purpose it is known to use filters, referred to as “die-cut part”, comprising a precision technical filtering media, in the most common case a square mesh monofilament fabric, wherein the size of the single meshes is uniform in space and time, in order to have a reasonable certainty of stopping any solid particle having size greater than the characteristic size of the meshes (all equal to each other). For this reason, the known square mesh synthetic monofilament precision technical fabrics are the ideal media for such a kind of application.

Regarding the sizing of such a square mesh technical fabric, the requirement consists in stopping the solid particles having the most common size. As we will see hereinafter, a typical square mesh monofilament fabric of the prior art is able to stop solid particles having size greater than or equal to its mesh opening value. The latter typically ranges between 20 and 100 microns, depending on the speaker sensitivity to contamination, which would require lower micronages, and to the emphasis given by the manufacturer to a good sound transmission, which instead would require a fabric as open as possible.

From all the above a limitation of the prior art already comes up. In fact, at present there is no optimal design of the fabric, which ensures at the same time the best possible protection and sound transfer without problems of distortion.

With regard to the acoustic requirements, there are several factors which would impose the use of a fabric as open as possible.

First of all, a too closed protective fabric would reduce the sound emission to unacceptable levels. The small speakers of smartphones are extremely powerful considering their size and they reach values of sound pressure (SPL)>100 dB at a distance of 30 mm; nowadays no manufacturer would accept an excessive reduction in performance, from which there is the need of very open and “acoustically transparent” fabrics, obviously to the disadvantage of protection.

Moreover, there are strict requirements about the sound quality, which by now must be optimal, not only powerful but even with the lowest distortion. However, it should be said that, for the needs of aesthetic design, the speaker ports of smartphones and tablets are often very small (few holes with a diameter typically ranging between 1 and 1.5 mm): accordingly, through such openings a very high acoustic velocity (>10 m/s) is generated, which arises in non-linear range and which is accountable for the generation of undesired harmonic distortion of the acoustic signal throughout the fabric, either for THD (Total Harmonic Distortion), or HOHD (High Order Harmonic Distortion), or R&B (Rub & Buzz). All these acoustic quantities, which will be better described below, are index of sound quality and have to be minimized in order to meet the common standards in the industry of this field. Typical requirements are: THD<5%, HOHD/R&B<0.4%.

Among other things, in smartphones the problem of micro-speaker protection is becoming increasingly critical for some reasons:
1. More and more powerful micro-speakers, with diaphragm excursion already considerably higher than 0.5 mm, whereby the air volume set in motion is very high and very open meshes are needed in order to guarantee the correct sound transmission.
2. Micro-speakers equipped with extremely powerful magnets, in order to achieve the above-mentioned high powers. The strong generated magnetic field risks to attract inside the speaker the metallic particles present in the environment, with the consequent need that the protective mesh ensures an improved protection from particles compared to the past.
3. Smaller and smaller acoustic ports (think of the minimal slots left between the display and the phone shell, with a total area of few mm²), generating higher and higher acoustic velocities and which therefore require a perfectly optimized acoustic fabric, in order to keep under control the sound output quality.

Specific tests are carried out in order to assess the acoustic properties of each mesh which will affect the sound emission of the device wherein it is inserted. These measurements may be of fluid dynamical nature, carried out on the fabric itself, or actual acoustic tests, carried out on test speakers containing inside them the acoustic fabric under consideration.

The measurement of the specific airflow resistance, which is a fundamental parameter quantifying the resistance of the fabric to the passage of the sound wave, belongs to the first group. A force of such a kind, resisting to the air flow generated by the sound wave, turns out to be the source of the previously mentioned harmonic distortions. The resistance is an intensive quantity, not depending on the size of the sample, proportional to the sound pressure and inversely proportional to the airflow velocity through the sample. It is generally represented by the measurement units MKS Rayls=[Pa/(m/s)].

As is known, this quantity depends on the airflow velocity through the fabric; when the latter gets too high, generally beyond 1 m/s, the dependency is no longer linear. In the majority of applications of micro-speakers in consumer electronic devices (smartphones and tablets), the acoustic mesh is subjected to crossing flows significantly above the linear range of the specific acoustic resistance. Therefore, it becomes necessary to measure how much the mesh modifies the acoustic signal for high acoustic velocities, in order to estimate the sound distortion which the mesh could introduce into the device.

Dedicated tests therefore provide for measuring the specific resistance by imposing crossing velocities which are high and extended even to the non-linear range, up to values of 30-40 m/s. The curve of resistance as a function of velocity shows a slope characteristic of the tested material. The lower this slope, the more the curve approaches linearity, the less will be the distortions generated by the acoustic mesh to the acoustic signal. It is therefore evident that low values of resistance in the non-linear range will be preferable and will be an indicator of the quality of a mesh for its use in the protection of the acoustic components of the electronic devices.

The test and the parameters just described are indicators of the acoustic properties of the acoustic mesh which will affect the performance of the device in which they are applied. The assessment of the performance level of the device is made instead by other kinds of tests which are carried out directly on the final component, that is in this case the speaker (or micro-speaker) on which the acoustic and protective mesh is assembled.

Examples of these measurements are the quantities of SPL, THD and HOHD/R&B already mentioned above and which are measured by a single test, normally carried out on a reference model of micro-speaker and representative of the application under consideration, comprehensive of the installation of the acoustic mesh.

Regarding the already mentioned case of very performant speakers which generate particularly high air velocities, it gets also necessary to analyse how the fabric affects the generation by the device of the noise caused by the flow (“flow noise”). In particular, we are talking about wide frequency spectrum noise, generated by air jets emitted by the external ports of the speaker with high velocity, measurable by an additional dedicated test.

All of the aforementioned requires that the acoustic mesh has a high open area, in order to minimize the resistance of the material to the passage of air, which is beneficial for reducing both the acoustic insertion loss and the sound distortion. In parallel, the mesh itself must also ensure a suitable protection to the acoustic components and therefore have a suitably limited mesh size.

In conclusion, a reduction of the mesh opening size is needed while preserving the void/full ratio, that is the open area of the fabric, in order not to deteriorate the acoustic performance. For the square meshes of the prior art, these two antithetical requirements are only partially met, as we will see now.

In order to reduce the mesh size there are two available ways to go. The first one provides for the possibility of inserting an increasing number of threads of the fabric, the diameter being fixed. The second one provides, instead, for using the same number of threads, but with a higher thread diameter. It becomes clear that in both cases the void/full ratio decreases and that the passage of air and acoustic performance of the fabric would deteriorate. Therefore, in order to obtain a smaller size of the mesh while keeping the void/full ratio constant, it is intuitive to think that the only possible way consists in using an increasing number of threads but at the same time a smaller and smaller diameter of the threads. This third way, apparently ideal, however shows two limits:
1. a technological limit in the processing of the yarn, whereby below a specific diameter it is neither possible to extrude the monofilament nor even weave it;
2. a technological limit during the weaving process, whereby it is not possible to increase beyond a fixed threshold the number of threads per cm. In some cases, where the application imposes high protection requirements and a mesh having a particularly small size is needed, the use of a lower diameter of the thread might impose a structure having a number of threads impossible to achieve.

It is therefore evident that the aforementioned traditional choice, namely the one of decreasing the mesh size, involves necessarily the disadvantage of decreasing the open area of the mesh itself too. As a result, when the square meshes of the prior art are too narrow, the acoustic velocity through them becomes too high, with a negative impact on the performance of the speaker: acoustic insertion loss in the crossing of the fabric itself, even if we are talking about a new and not yet contaminated fabric, and acoustic distortion phenomena: THD (Total Harmonic Distortion), HOHD (High Order Harmonic Distortion) and Rub & Buzz. In the case of a particularly performing speaker and with high crossing acoustic velocities through the mesh, even undesired “flow-noise” effects may occur, that is the generation of wide spectrum noise, which further deteriorate the quality of the acoustic emission. Furthermore, when the square mesh of the prior art becomes partially contaminated owing to its use, the above effects are even more serious and they may easily make the whole device unusable.

From all the above we deduce that the choice of the best square mesh acoustic fabric of the prior art always constitutes a compromise: very closed fabrics favour the protection but they are less performing with regard to sound transmission (even as new, without contamination); more open fabrics instead offer an acceptable “acoustic transparency” but they show a too large mesh opening in order to effectively stop all the particles of contaminant.

The publication WO 2011/132062 A1 discloses a double layer textile construction, in which a laminated continuous film is present having a waterproof function against the intrusion of water in the acoustic components of electronic devices.

WO 2010/124899 A1 relates to a system for the production of a filter consisting of a composite fabric material.

The publication WO 2017/134479 A1 relates to a composite multilayer structure, usable as sub-component in electronic and acoustic items.

WO 2005/039234 A2 discloses a protective structure comprising a punched metal foil.

### SUMMARY OF THE INVENTION

The primary object of the present invention is to provide a protective element made of a high-performance synthetic monofilament fabric or woven mesh, to be used as a protection for the speakers present in electronic devices and in smartphones.

In particular the object of the present invention is to provide a protective element made of fabric of the aforementioned kind which, unlike the fabrics of the prior art, shows an improved capability in stopping the solid particles at the same acoustic performance or, alternatively, shows improved acoustic characteristics (that is, lower acoustic insertion loss and lower distortions) at the same capability of protection from the particles with respect to the prior art.

These and other objects are achieved by the element of the invention according to claim 1. Some preferred embodiments of the invention result from the remaining claims.

In relation to the square mesh fabrics of the prior art, having comparable characteristics of air passage and sound transmission, the protective element of the invention offers the advantage to present an improved capability of protection from contaminating particles.

In relation to the fabrics of the prior art, with regard to the capability of protection from solid contaminants, the element of the invention shows improved sound transmission properties, which improve the acoustic performance of the component on which it is installed.

Naturally, for each application of micro-speakers inside an electronic device, it is possible to choose the structure of the fabric more suitable for the purpose and obtain a partial improvement, both in the first scope (better protection) and in the second one (better sound transmission) and anyway to a globally greater extent than the one allowed by the prior art.

The fabric of which the element of the invention is made may be manufactured by weaving either monofilament or multifilament synthetic material. In its optimal form the fabric of the invention is manufactured using a monofilament.

The material from which the starting monofilament or multifilament is made may be a synthetic technopolymer belonging to the family consisting of polyesters, polyamides, polyaryletherketones, polyparaphenylene sulphide, polypropylenes, perfluorocarbons, polyurethanes, or polyvinyl chlorides. As an alternative, the base monofilament or multifilament material by which the fabric of the element of the invention is manufactured may be an artificial polymer belonging to the family consisting of cellulose or viscose.

Whenever an optimal protection not only from solid particles but also from splashes of liquids is desirable, the fabric of the invention may be implemented with a hydrophobic and/or hydro-oleophobic treatment of fluorocarbon or silicon nature or of other kind.

The monofilament by which the fabric of the invention is made may have a diameter ranging from 10 μm to 90 μm, preferably from 17 μm to 40 μm, both in the warp direction and in the weft direction. The fabric of the invention may be manufactured by a textile structure requiring a number of threads per cm ranging from 23 to 350.

The fabric may be manufactured with different textile architectures and it may be made using threads having different nature or different diameter in the weft and in the warp. The mesh opening of the fabric of the invention may have a shorter side in the range from 5 to 150 μm.

It should be noted in particular that in the textile configurations of the prior art, defined as “Tressen”, “Reps”, or “Dutch weave”, the dimensional ratio shorter side/longer side of the mesh openings is always lower than 0.25 which is a condition wherein the saturation occurs, that is the contact among the threads which extend parallel to each other.

The present invention—in which the aforementioned dimensional ratio is between 0.3 and 0.9—is on the contrary designed to maximize the crossing section for an air flow (and therefore also a sound flow) which crosses orthogonally the material, minimizing the insertion loss in deciBels, whereas for the fabrics of the prior art there is only the need to minimize the size of the pore through which the fluid passes, specifically for the filtering applications in which the loss of load through the filter is not a problem.

Therefore, in the prior art fabrics defined as “Tressen”, “Reps”, or “Dutch weave” the threads of one of the two directions are brought to be adjacent to each other, reaching the so called “saturation”, leaving only minimal crossing openings, suitable to ensure an extreme filtering capability, however generating at the same time very high losses of load, absolutely unacceptable if one plans to transpose the same textile configuration in a product for acoustics, intended for minimizing the loss in deciBels (“insertion loss”).

### BRIEF DESCRIPTION OF THE DRAWINGS

The above objects, advantages and characteristics result from the following description of some preferred embodiments of the element of the invention provided, by way of non-limiting examples, in the figures of the attached drawings.

Wherein:

FIG. 1 illustrates a typical smartphone with its acoustic ports highlighted, provided at the speakers with the fabric of the invention;

FIG. 2 shows by way of example the section of a conventional smartphone, taken at the acoustic port of the lower speaker, equipped with the fabric protective element of the invention;

FIGS. 3, 4a and 4b illustrate the square mesh of a fabric of the prior art;

FIG. 5 illustrates the mesh of FIG. 3, when clogged by a particle of contaminant;

FIGS. 6, 7a and 7b illustrate the rectangular mesh of the fabric protective element of the invention;

FIGS. 6a and 6c represent a portion of a filtering open mesh monofilament fabric of the prior art, used as a basis for the comparison with the corresponding embodiments of the fabric of the protective element of the invention;

FIGS. 6b and 6d represent two different embodiments of the open mesh monofilament fabric of the invention, taken as an example and compared with the fabrics of the prior art of FIGS. 6a and 6c, respectively;

FIG. 8 illustrates the mesh of FIG. 6, when clogged by a particle of contaminant;

FIG. 9 shows the comparison of the mesh opening value between a fabric of the prior art and two feasible embodiments of the fabric of the invention;

FIG. 10a shows the comparison between the values of the specific airflow resistance R(0.2), for the three fabrics of FIG. 9, in linear conditions (crossing velocity=0.2 m/s);

FIG. 10b shows the comparison between the values of the specific airflow resistance R(20), for the three fabrics of FIG. 9, in non-linear conditions (crossing velocity=20 m/s);

FIG. 11a shows the comparison between the values of sound pressure (SPL) emitted by a reference speaker with each of the three aforementioned fabrics interposed;

FIG. 11b shows the comparison between the values of the total harmonic distortion (THD) of the emitted signal with respect to the input frequency to a reference speaker with each of the three aforementioned fabrics interposed and normalized with respect to the baseline measured with no fabric;

FIG. 11c shows the comparison between the values of high order harmonic distortion (HOHD) of the emitted signal with respect to the input frequency to a reference speaker with each of the three aforementioned fabrics interposed and normalized with respect to the baseline measured with no fabric;

FIG. 11d shows the comparison of the increase in the values of undesired sound power spectral density (Power Spectral Density, PSD) with respect to the baseline measured with no fabric, emitted beyond the expected frequencies, that is as flow noise, by a reference speaker with each of the three aforementioned fabrics interposed;

FIG. 12 schematically illustrates the components used for the acoustic tests referred to in FIGS. 11a, 11b, 11c;

FIG. 13 schematically illustrates the components used for the acoustic tests referred to in FIG. 11d;

FIG. 14 schematically illustrates the components of a typical equipment for measurements in a continuous air flow, used for the test of the specific airflow resistance referred to in FIGS. 10a and 10b.

### DETAILED DESCRIPTION OF PREFERRED EMBODIMENTS

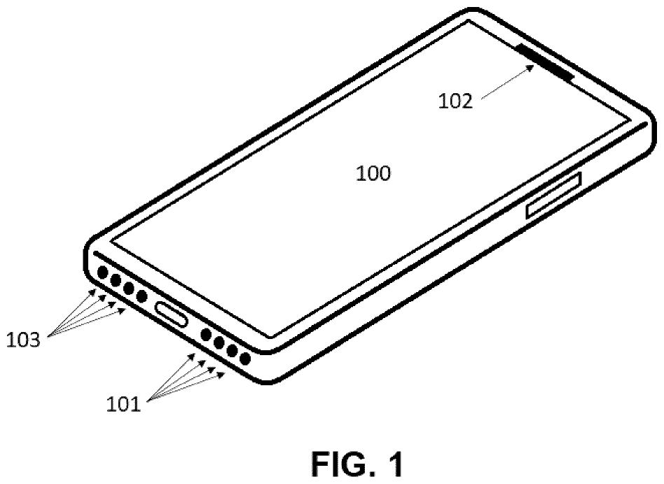

In the example of FIG. 1, the smartphone 100 is provided with an acoustic port 102 at the upper speaker, named “receiver” and intended to transfer the sound to the user ear during the listening on the phone, as well as to emit stereophonic sound in the environment when the smartphone provides this function too. A second set of openings 101 allows sound emission of the lower speaker (“loudspeaker”) for listening on speakerphone, for audio playback and for the ringtone. Normally in smartphones there are also other openings 103 for microphones, pressure sensors or venting ports in order to allow the equalization of the internal pressure in waterproof devices.

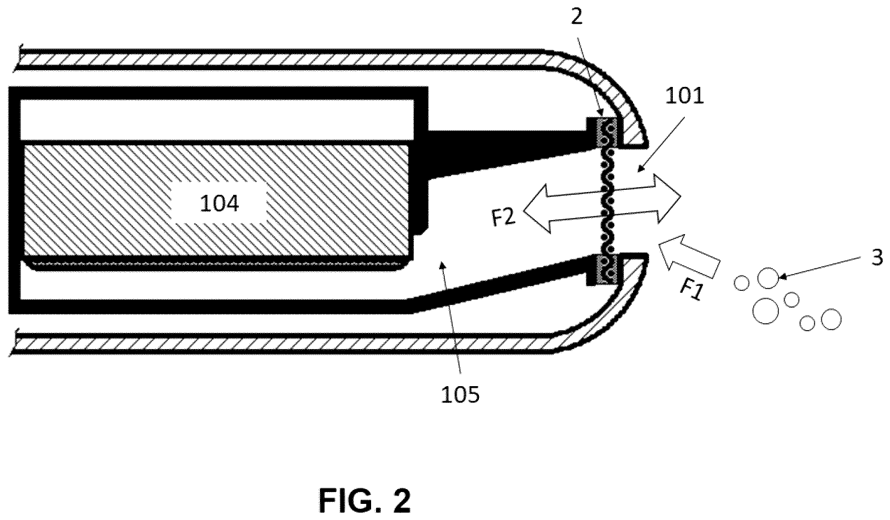

FIG. 2 illustrates, in section, the typical arrangement of the components inside the smartphone, at the port 101 of the lower speaker or “loudspeaker” 104. The latter is in communication with the external environment through a narrow channel 105, ending on the acoustic port 101.

The speaker of the smartphone of the prior art is protected, from the intrusion of contaminating particles 3 and from sprays of water, by a shaped element 2 made of a square mesh synthetic monofilament fabric, interposed between the acoustic port 101 and the channel 105, or locked within the channel itself in another embodiment.

In use, the fabric forming the element 2 is required to ensure the correct passage of the sound waves generated by the speaker 104 (flow F2, alternate in the two directions according to the characteristics of the acoustic signal), but at the same time it has to stop the particles of contaminant risking to reach the speaker itself (flow F1, from the exterior to the interior of the smartphone).

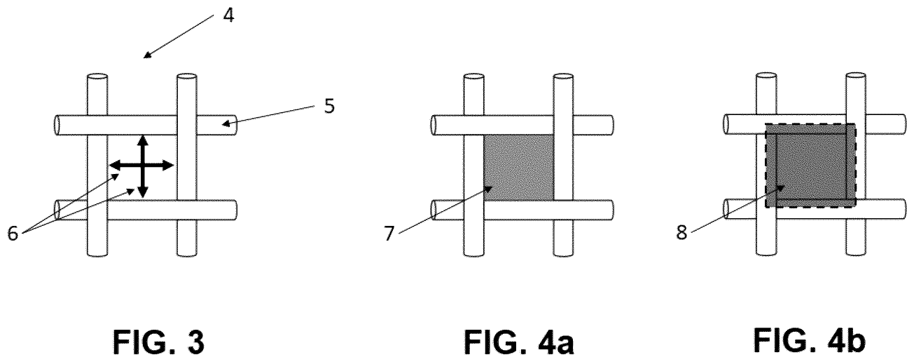

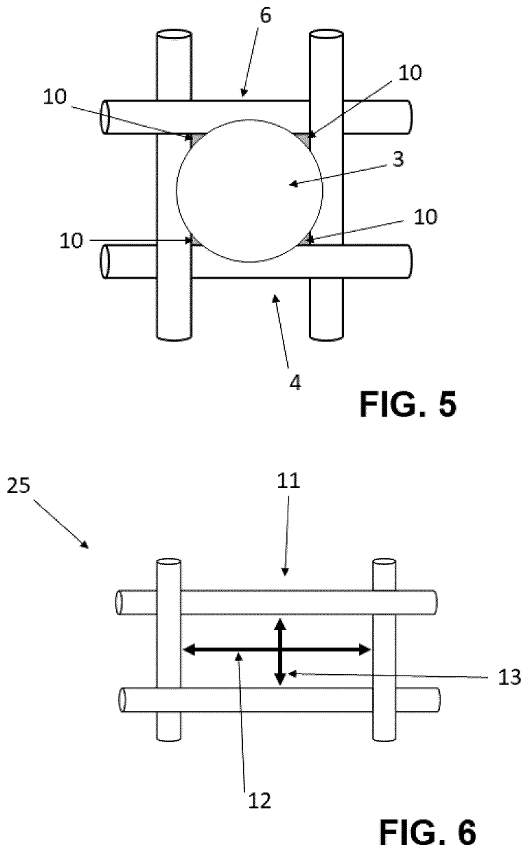

In the prior art illustrated in FIGS. 3, 4a and 4b, the mesh 4 of the fabric 2 is square and it consists of threads 5 which form the respective sides 6 of the square mesh 4.

The open area of the mesh 4 itself of the prior art is computed as the percentage ratio between the surface of the smaller square 7, comprised between the profile or the internal edge of the threads 5 which form the sides 6 of the mesh 4 (FIG. 4a) and the surface of the larger square 8, measured up to the centre line of the threads 5 themselves (FIG. 4b).

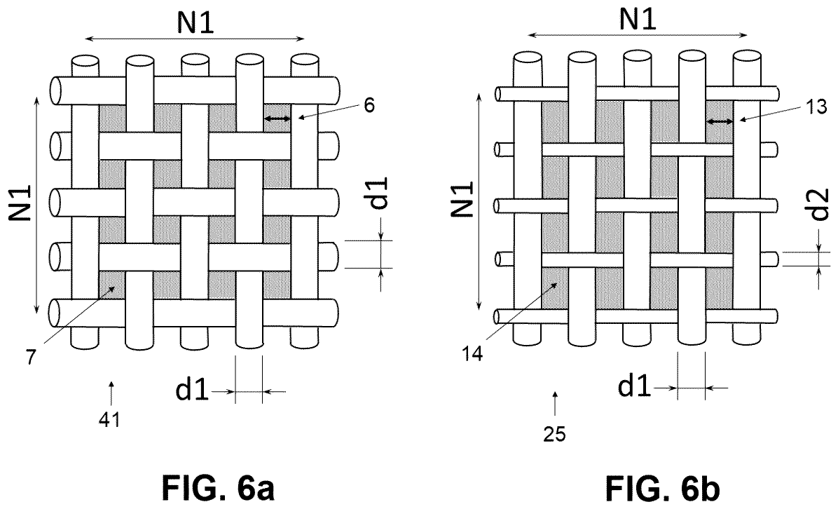

During the usage of the electronic device in unclean environments, the mesh 4 of the prior art is exposed to the intrusion F1 of the contaminant, which leads to intercept a particle 3 of contaminant which typically has a diameter comparable with the length of the side 6 of the square mesh itself; the opening of the latter is thus clogged, leaving free for the passage of the sound waves the little portions 10 only of the surface of the smaller square 7 of the mesh 4 (FIGS. 5 and 4a).

As a consequence of the clogging of the mesh of the prior art fabric, typically a higher loss of load in the crossing of the fabric itself occurs, leading to the deterioration of the speaker performance: higher “insertion loss” with loss of radiated sound pressure, harmonic distortion (THD) or Rub & Buzz (R&B) phenomena. The final consequences are dependent on the severity of the received contamination, but in very many cases it is a more than tangible phenomenon, which may also totally compromise the use of the device within 1-2 years.

In addition to all the above, the choice of the best square mesh acoustic fabric (that is the prior art one) is always the result of a compromise, even considering only the performance of the new and not yet contaminated fabric. The fabric is described by its values of mesh opening as far as the protection is concerned and of specific airflow resistance (measured in MKS Rayls) as an index of its acoustic transparency: these two quantities behave in opposite ways as the density of threads per cm changes, therefore it will be impossible to minimize both of them. In fact, giving preference to the protection from the solid particles a technical fabric particularly closed and therefore poorly performing in terms of sound transmission already as new, with no contamination, should be selected; on the contrary, when selecting materials having very low specific airflow resistance and therefore excellent “acoustic transparency”, then we are forced to accept values of the mesh opening which do not guarantee a suitable protection from solid contaminants.

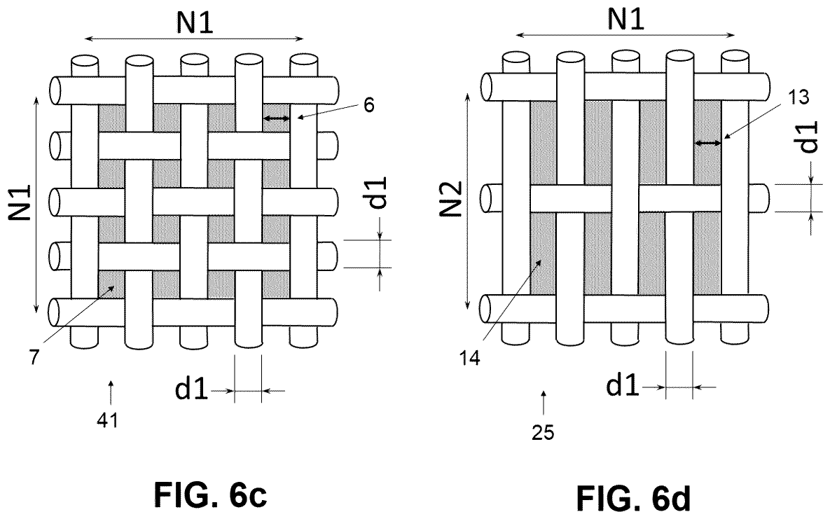

In order to overcome these drawbacks of the prior art, the protective element of the invention is made of a fabric 25 having meshes 11 with rectangular shape, having a longer side 12 and a shorter side 13 (FIG. 6). In the figure a rectangular mesh wherein the longer side is arranged in the weft direction is shown, but this is not binding: the invention also provides the opposite configuration, wherein the longer side is arranged in the warp direction.

The fabric 25 may be manufactured with different open-mesh textile architectures, having the common characteristic of being asymmetrical in the two directions of weft and warp, with particular regard to the linear density of the threads per centimetre and/or to the diameter of the threads. Therefore, the numerical density of threads of the weft will be different from the warp one and/or the weft threads will be different from the warp threads with regard to the thread diameter or to the nature of the yarn.

As a result, it is possible to manufacture the fabric of the invention with a rectangular mesh, particularly as a function of the construction parameters of linear density, diameter of the threads and their mutual balancing in the asymmetrical configuration.

For this purpose, the ratio between the linear densities/cm of the weft threads and of the warp threads of said mesh 11 in the respective directions is preferably in the range between 0.4:1 and 2.5:1. Furthermore, preferably the ratio between the diameter of the warp threads and the diameter of the weft threads of said mesh 11 is in the range between 0.5:1 and 2:1.

FIG. 6a illustrates a portion of a prior art fabric 41 having the same density of threads per cm (N1) both for the warp threads (vertical in the Figure) and weft threads (horizontal in the Figure). Moreover, it has an identical value of the thread diameter (d1) both for warp and for weft. The open mesh 7 is square with identical values of the mesh opening 6 in the two directions (FIG. 6a).

In FIG. 6b a possible embodiment of the fabric 25 of the protective element of the invention is instead proposed, wherein only the diameters of warp and weft threads differ from each other. As a consequence:
The number of the warp threads per cm according to the invention (N1, vertical threads in FIG. 6b) is identical to the prior art one of FIG. 6a.
The number of the weft threads per cm according to the invention (N1, horizontal threads in FIG. 6b) is identical to the prior art one of FIG. 6a.
The diameter of the warp threads according to the invention (d1, vertical threads in FIG. 6b) is identical to the prior art one of FIG. 6a.
The diameter of the weft threads according to the invention (d2, horizontal threads in FIG. 6b) is instead lower both than that of the warp threads according to the invention (d1, FIG. 6b) and the diameter of the threads of the prior art fabric (d1) for both the directions, FIG. 6a.

FIG. 6c illustrates a portion of the prior art fabric 41, having identical density of threads per cm (N1) and identical thread diameter (d1) both for the warp threads (vertical in the Figure) and for the weft threads (horizontal in the Figure). The material is therefore perfectly symmetrical.

In FIG. 6d a possible embodiment of the fabric 25 for the formation of the protective element of the invention is instead proposed, wherein only the densities of threads per cm for the warp threads and for the weft ones are different from each other. As a consequence:
The number of the warp threads per cm (N1, vertical threads in FIG. 6d) is identical to that of the prior fabric of FIG. 6c.
The number of the weft threads per cm according to the invention (N2, horizontal threads in FIG. 6d) is lower than that of the warp threads according to the invention (N1, FIG. 6d) and than the number of threads per cm of the prior art fabric (N1 in both the directions, FIG. 6c).
The diameters of the warp and weft threads according to the invention (d1, both vertical and horizontal threads of FIG. 6d) are identical to each other and equal to the corresponding values of the prior art of FIG. 6b.

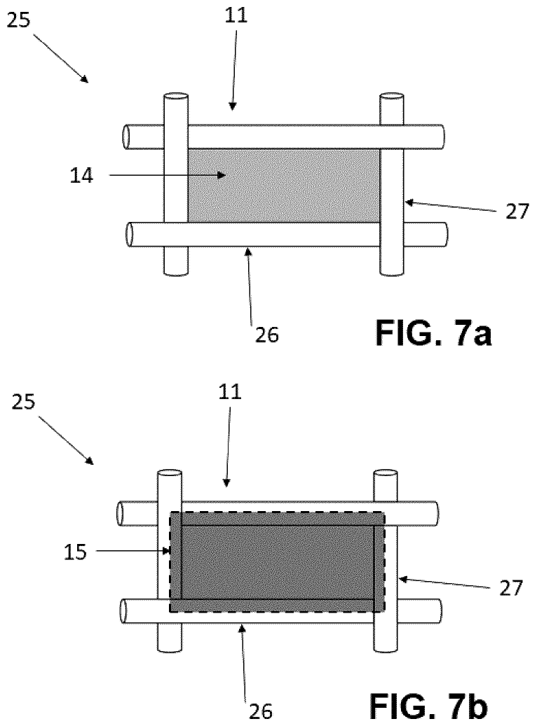

The open area of the mesh 11 is computed as the percentage ratio between the surface of the smaller rectangle 14, measured between the profile or the edge of the threads 26, 27 facing the interior of the mesh 11 and forming the respective sides thereof (FIG. 7a) and the surface of the larger rectangle 15, the latter being measured up to the centre line of the aforementioned threads 26, 27 (FIG. 7b). The sides of the rectangular mesh of the fabric of the invention are such that the ratio between the shorter side and the longer side is in the range between 0.3 and 0.95. This may apply for both the situations in which the shorter side of the mesh is in the weft direction, and in the warp direction: both these options are covered by the present invention.

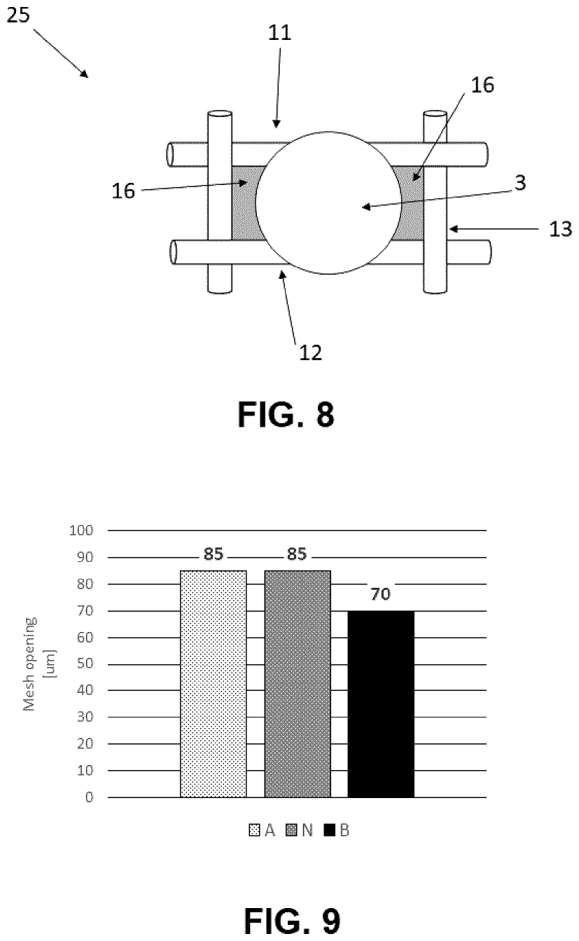

When on the mesh 11 of the fabric 25 a particle of contaminant 3 coming from the outside and having a diameter comparable to the length of the shorter side 13 of the rectangular mesh 11 itself impacts, the opening of the latter is not completely clogged as in the case of the known mesh 4 having a square shape, and large portions 16 of the open area of the mesh 11 itself are instead left for the passage of the sound flow (FIG. 8).

In this way the dual aim of stopping the solid particle 3 on the mesh 11 and leaving to the sound flow F2 the possibility of crossing such a mesh 11 going through the free portions 16 thereof is reached. The acoustic insertion loss, which otherwise the presence of contaminant matter would have caused in the prior art case, is thus reduced.

Thanks to the invention, making rectangular meshes 11 having the shorter side 13 even shorter than the side 5 of the square mesh 4 of the prior art fabrics 2 has also been made possible, in this way further increasing the protection of the fabric 25 of the invention from the intrusion of particles. Further considerations related to the stability of the fabric and to the shape of the contaminant particles suggest of maintaining a ratio between the size of the shorter side 13 and the one of the longer side 12 of the rectangle in the range between the values of 0.3 and 0.95 (this applies both when the lower size is in the weft direction and in the warp direction).

From the present description it can be seen that, by suitably dimensioning the ratio between the longer and shorter sides of the rectangular mesh, it is possible to obtain:
a larger open area compared to a square mesh, fixing the size of the shorter side of the rectangle equal to the square one. For example, fixing the diameter of the thread equal to 24 μm, with a square having a side equal to 85 μm an open area of 60% is obtained, whereas with a rectangle having sides 85×115 μm the open area is equal to 64%. A gain in the open area is obtained, and therefore a better acoustic transparency with lower specific airflow resistance (MKS Rayls) and lower acoustic insertion loss (dB insertion loss), being equal the size of the stopped contaminant particles;
a size of the shorter side of the rectangle lower than the square one, the open area being equal. For example, when fixing the diameter of the thread equal to 24 μm, a square having an open area equal to 60% has sides equal to 85 μm, whereas a rectangle having an open area equal to 60% has sides equal to 70×110 μm. At this point, a protection even against smaller particles (70 microns instead of 85) may be obtained, while maintaining the same open area and therefore the same air passage and identical sound transmission;
a size of the shorter side of the rectangle lower than the square one and even a larger open area; for example, when fixing the diameter of the thread equal to 24 μm, a square having an open area equal to 60% has sides equal to 85 μm, whereas a rectangle having an open area equal to 63% has sides equal to 110×67 μm (in this example the rectangular configuration of the mesh has been further enhanced with the choice of different thread diameters: 24 microns in the warp and 19 microns in the weft). A material of this kind would present some advantages in both the performance fields: protection even against smaller particles and lower specific airflow resistance in comparison with the square mesh of the prior art, with resulting better sound transmission with lower losses.

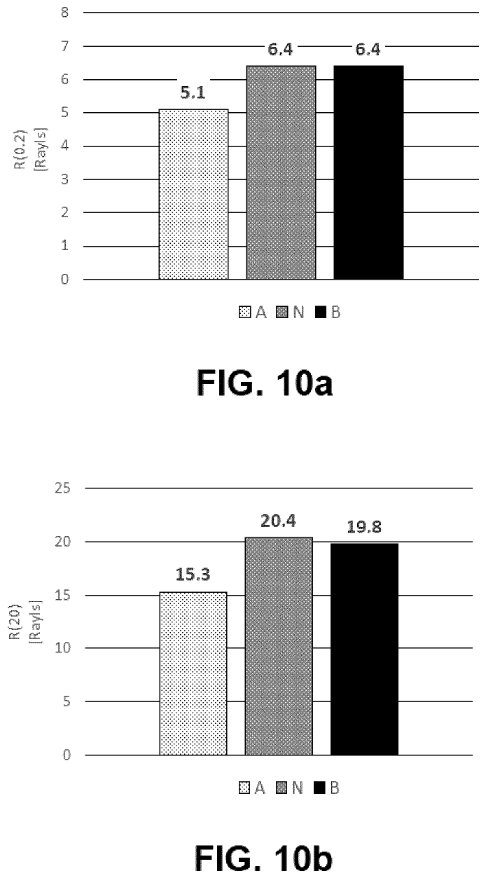

The diagrams shown in FIGS. 9, 10a, 10b, 11a, 11b, 11c and 11d represent the results of the various tests, hereinafter described in detail and carried out on a square mesh fabric 2 of the prior art and on two variants of the rectangular mesh fabric 25 of the protective element of the invention, in order to show the better performance allowed by the invention herein introduced.

In this particular case, the materials object of the comparison are the following:
the fabric 2 of the prior art, specifically a monofilament fabric formed by square meshes each having size equal to 85×85 μm and the open area of the mesh equal to 60%; the material has a thread density equal to 90×90 threads/cm, a specific airflow resistance in the linear range R(0.2) equal to 6 MKS Rayls, and other characteristics as result from the measurements referred to in the attached figures;
the fabric 25 of the element of the invention, in its first exemplary variant called “A”, formed by a synthetic monofilament rectangular mesh fabric, in particular made of polyester, wherein each rectangular mesh has size equal to 85×115 μm and an open area of the mesh equal to 64%; the density is equal to 90×70 threads/cm in both the weft and warp directions, whereas the specific airflow resistance has a nominal value of 5 MKS Rayls in the linear range;
the fabric 25 of the invention, in its second exemplary variant called “B”, formed by rectangular meshes each having size equal to 110×70 μm and an open area of the mesh equal to 60%; the density is equal to 75×105 threads/cm and the specific airflow resistance equal to 6 MKS Rayls in the linear range.

By way of comparison, in order to show the advantages of the invention here introduced, on the aforementioned exemplary materials measurements of mesh size, of airflow resistance in the linear and non-linear range and of acoustic performance when the fabrics themselves are installed on a test speaker have been collected. Hereinafter the execution details of the abovementioned tests are provided.

The mesh opening measurement in the two directions, 12 and 13 in FIG. 6, has been carried out by a microscope and image digital processing. The mesh opening normally corresponds to the size of the stopped contaminant particle; in the case of rectangular mesh, the fabric is able to stop particles having a size equal to the smaller one of the mesh openings in the weft and the warp, 12 and 13, respectively. Such “effective” value of mesh opening has been selected as an indicator for the two fabrics A and B, examples of embodiment of the present invention, whereas for the square mesh fabric N of the prior art the value of the mesh 6 opening of FIG. 3 has been reported, which is the same in both warp and weft directions.

The histogram of FIG. 9 collects the values of this effective mesh opening, for the prior art fabric N and for the two examples of embodiment of the invention, A and B.

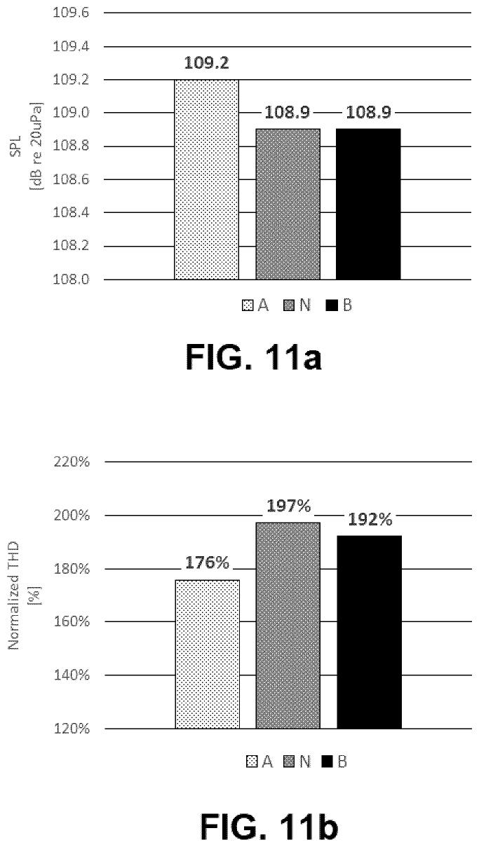

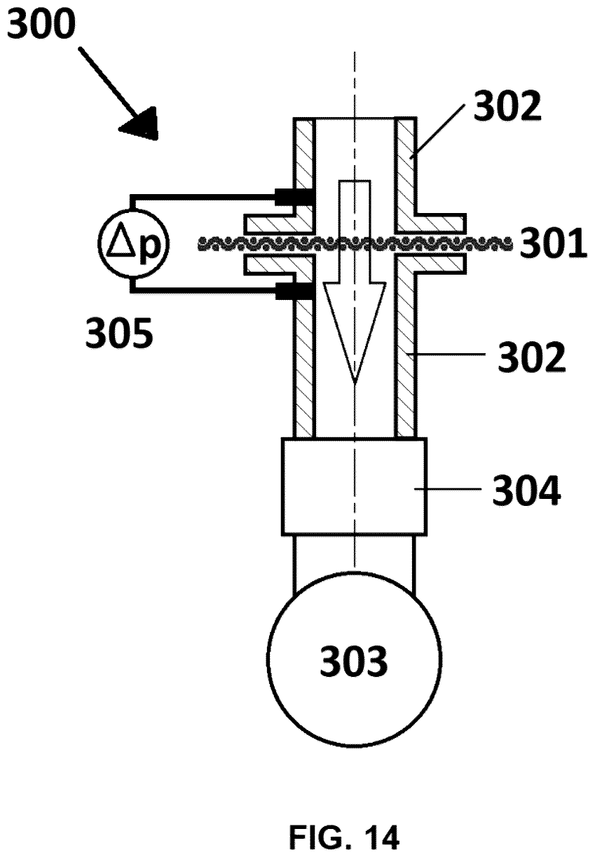

For the evaluations of the specific airflow resistance through the mesh a continuous air flow (DC-flow) measuring equipment has been instead used, which generated the histograms of FIGS. 10a and 10b hereinafter described. FIG. 14 synthetically describes this equipment 300, intended to clamp the fabric sample 301 between two flanges having known area (typically 10-20 cm²), by a suction system 303 which forces a predefined air flow through the fabric sample 301, accurately checking the flow rate thereof by means of a flow meter 304. From the flow rate measurement and from the known area of the crossing section is then possible to compute the crossing velocity of the sample, normally expressed in m/s.

During the test, a differential pressure sensor 305 detects the pressure difference between the two sides of the fabric sample 301 having known area; from the ratio between this pressure drop (expressed in Pa) and the airflow velocity (in m/s) the specific airflow resistance is then derived, expressed in the units MKS Rayls=Pa/(m/s).

A first set of evaluations of the specific airflow resistance R(0.2) of the fabric in the linear range, that is with a velocity equal to 0.2 m/s, generated the data of FIG. 10a, with the considerations that will be hereinafter reported. For the specific airflow resistance in the non-linear range, that is the turbulent one, the equipment used is the one described above and the parameter used is instead the resistance factor R(20), that is the specific airflow resistance measured at a crossing velocity through the mesh equal to 20 m/s. The lower is the value of R(20), the more optimized the fabric will be from the acoustic point of view and it will limit any distortion of the sound to be transmitted. FIG. 10b shows the comparison between the data of R(20) of the prior art fabric N and of the two examples A and B of the invention.

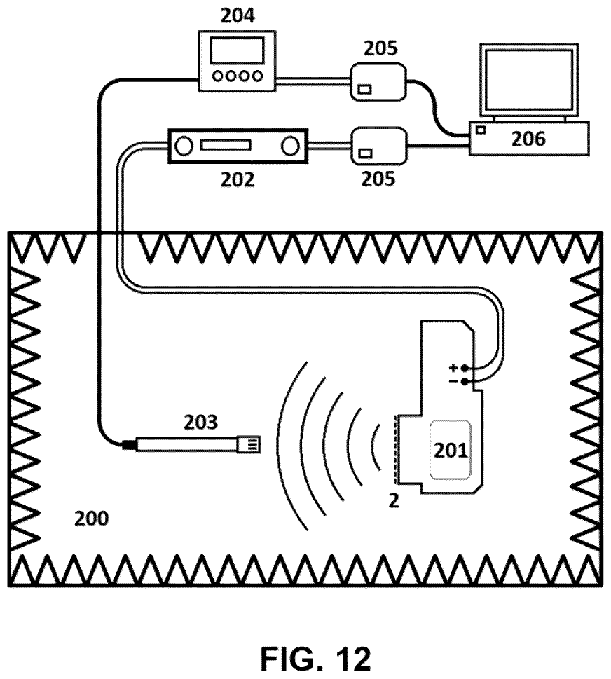

With regards to the measurement of the acoustic performance quantities of the speaker, that is SPL, THD and HOHD, the test system schematically described in FIG. 12 has been used. It comprises a reference speaker module 201, located in an anechoic environment 200; on the acoustic port of the speaker the fabric sample 2 to be tested is applied in order to compare the effect thereof on the acoustic emission of the speaker. The latter, suitably driven by an amplifier 202, emits a sine-wave having an increasing frequency in the audible sound range 100 Hz-20 kHz, which is collected by a reference microphone 203 located at the given distance of 30 mm from the speaker and is then processed/amplified by an amplifier/conditioner for dedicated microphone 204. Any input and output signal undergoes the analog-to-digital conversion (or vice versa) by means of dedicated sound cards 205, before being analysed and processed by the management PC 206, which computes the quantities SPL, THD and HOHD/R&B, commented below, versus frequency.

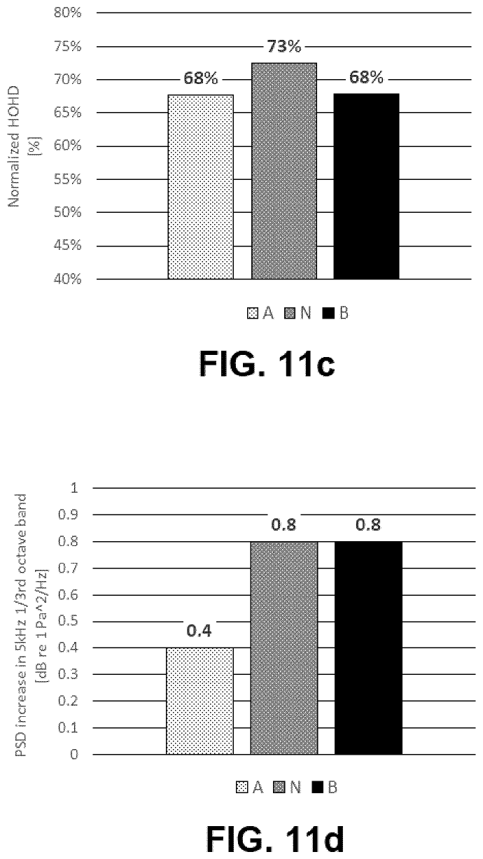

The sound pressure level (Sound Pressure Level, SPL), expressed in decibels (dB re 20 uPa), is important to assess if the applied fabric reduces the speaker emission in an acceptable or an excessive way. Lower values of reduction of SPL (that is “insertion loss”) are preferable. FIG. 11a shows the values of SPL for the three fabrics A, B, and N object of the comparison, with respect to the reference speaker working with an input frequency equal to 620 Hz: higher values of SPL are an index of better performance.

The total harmonic distortion (THD) is instead the ratio expressed in percentage between the mean square of all the harmonics generated by the distortion and the original signal (or fundamental harmonic) input to the device. It is an index of how much the original signal has been corrupted in the acoustic transposition of the electric signal, above all due to the interposition of an acoustic mesh.

FIG. 11b reports the normalized values of THD detected for the examples A, B, and N illustrated in this text, in the above conditions.

The high order harmonic distortion (HOHD) is a particular case of distortion, where the sum of the harmonics generated by the distortion is computed from the tenth harmonic forward, in the case herein studied. The quantity under discussion focuses attention on the highest harmonics undesirably generated, which typically are indicators of the fact that some component in terms of mechanics is generating vibrations, undesired frictions or shocks adding noise to the emission of the device, which is why this quantity is also defined as Rub&Buzz (R&B). As the fabric is crossed by alternating air flows (sound wave), it may vibrate and also affect this kind of distortions.

FIG. 11c shows the evaluations of normalized HOHD in the conditions and for the cases herein explicated, comprising an example N of the prior art and two examples A, B of the herein described invention.

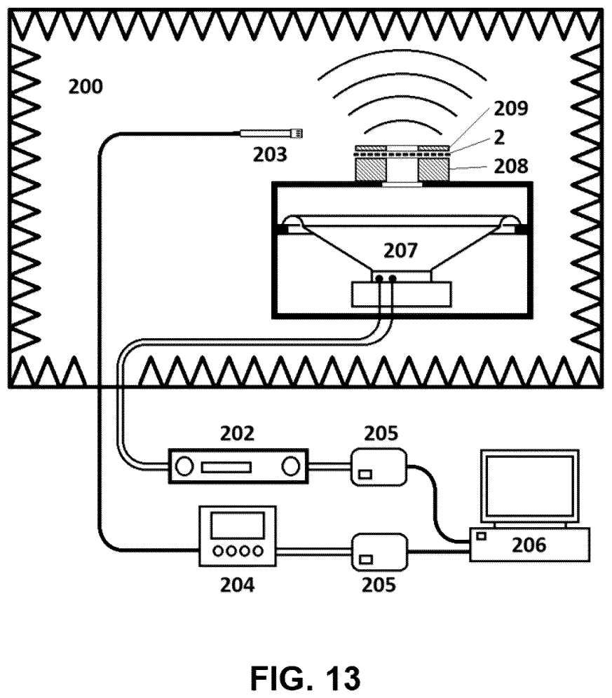

Finally, for the measurement of the flow noise the dedicated test schematically shown in FIG. 13 has been set up. It comprises a high-power reference speaker 207, emitting intense acoustic volume velocity through a dedicated channel 208 provided with a slot 209 having very small size (7.8 mm×1.2 mm), below which the fabric 2 to be tested is placed, and a reference microphone 203 is placed outside the primary flow, 45 mm from the axis and 15 mm above the plane of the fabric. The remaining equipment, comprising the amplifiers 202, 204, the sound cards 205 and the PC 206, is equivalent to what is used for the preceding measurements, schematized in FIG. 12.

The input signal to the speaker must be filtered in order to include only frequencies below 2 kHz, since the flow noise problem instead concerns the high frequencies. Herein the input signal is a sinusoidal wave having a fixed frequency (620 Hz), which allows to simplify the estimate of the crossing acoustic velocity in the fabric and clearly separate, in the analysis phase, the harmonic distortion effects from the flow noise ones. The collected signal has been then processed computing the acoustic power spectral density (Power Spectral Density, PSD) as a function of the frequency, in order to better understand the distortion and noise causes altering the waveform. If the acoustic power related to frequencies outside the input signal is high, this means that there is a noise component adding undesired energy to the system, to which evidently the acoustic fabric located on the speaker channel has also contributed.

Computed with the above method, the PSD turns out to be a good indicator of the quality of the emitted acoustic signal, which is better for low values of PSD in the frequency range of interest.

If applied to a speaker, a fabric optimized for minimizing the flow noise will achieve incremental values of PSD (referred to the base level of the speaker without including any fabric) lower than a fabric not designed for such purpose.

FIG. 11d illustrates the measurements of the PSD increase with respect to the base level of the speaker not containing a fabric, referred to a fabric N of the prior art and to two examples A, B of embodiment of the present invention.

Therefore, the superiority of each of the two examples of embodiment of the invention when compared to the square mesh fabrics of the prior art appears from the performed tests.

In comparison with the prior art solution, which must reach a compromise between the protection and the acoustic performance, each of the two proposed solutions turns out to be an improvement for one of the two performance fields herein considered, without nevertheless sacrificing the other, but keeping for the latter similar or even slightly better results than those of the prior art.

For ease of reference, the above data are gathered in the following Table:

| | N | A | B |
|---|---|---|---|
| Mesh | square | rectangular | rectangular |
| Opening 13 (μm) | 85 | 85 | 70 |
| Opening 12 (μm) | 85 | 115 | 110 |
| Effective opening (μm) | 85 | 85 | 70 |
| Open area (%) | 60 | 64 | 60 |

wherein:
   the effective opening represents the size of the particles of the solid contaminant, stopped by the mesh. This size must be the lowest possible;
   the open area is the one for the passage of air through the mesh, affecting the acoustic parameters represented in the FIGS. 11a to 11d and the parameters of the air passage (FIGS. 10a to 10d). The value of the open area must be the highest possible.

From this Table it results that the fabric having mesh B offers the maximum protection against the crossing of the solid particles, without compromising the acoustic performance in comparison with the prior art fabric N.

For its part the fabric A offers the best acoustic performance, together with a protection against solid particles which is comparable to that one of the prior art fabric N.

More specifically, the above-described results show that:
The novel fabric A has the same effective mesh opening as the prior art fabric N (FIG. 9), resulting equivalent to it in terms of protection, as it is able to stop contaminant particles having similar size. At the same time, however, it is much better in acoustical terms, as proven by the direct and indirect measurements: it has lower airflow resistance in the linear (FIG. 10a) and non-linear (FIG. 10b) range, which is an index of better sound transmission, and it guarantees higher emitted sound pressure (FIG. 11a), with lower distortion (FIGS. 11b and 11c) and lower flow noise (FIG. 11d).
The novel fabric B is significantly better than the prior art N in terms of protection from contaminants, since it has a significatively lower mesh opening. However, this better performance is not obtained at the expense of the acoustic performance, which instead is fully comparable to that of the prior art fabric. This is proven by equivalent values of airflow resistance in the linear (FIG. 10a) and non-linear (FIG. 10b) range, similar emitted sound pressure (FIG. 11a) and equivalent emitted power as flow noise (FIG. 11d). For other measurements of acoustic performance, such as the total distortion THD (FIG. 11b) and, above all, the high order distortion HOHD (FIG. 11c), the invention example B is even an improvement also in these fields in comparison with the prior art.

Naturally, thanks to the greater freedom offered by the rectangular mesh solution, it will be possible to design other products, as embodiments of the present invention, ensuring a more balanced improvement of both the characteristics, protection and sound transmission, which in any case would be impossible with the square mesh acoustic fabrics of the prior art.

The fabric of the protective element of the invention may also be manufactured with threads of an artificial polymer belonging to the family consisting of cellulose or viscose, and it is preferably coated with a hydrophobic or hydro/oleophobic coating.

The mesh size of the fabric moreover lends itself to be varied in one or both the directions of weft and warp and it is also possible to provide yarns of different nature and/or different size, either in the same direction, or in the different weft and warp directions.

1. Textile-based protective element against the intrusion of contaminating particles and sprays of water into the acoustic components of consumer electronic devices, characterized in that it consists of a synthetic monofilament open-mesh fabric (25), wherein said mesh (11) has a rectangular shape, whose sides (12, 13) are made up of respective threads (26, 27), wherein said fabric (25) with open meshes (11) has an asymmetrical structure with regards to the number of threads per cm, in which the ratio between the linear densities/cm of the weft threads and the warp threads of said fabric in the respective directions is in the range between 0.4:1 and 2.5:1, and/or with regards to the diameter of the threads for the two directions of weft and warp, in which the ratio between the diameter of the warp threads and the diameter of the weft threads of said mesh (11) is in the range between 0.5:1 and 2:1.

2. (canceled)

3. (canceled)

4. (canceled)

5. Protective element according to claim 1, characterized in that said meshes (11) have rectangular openings, wherein the shorter side/longer side dimensional ratio is in the range between 0.3 and 0.9 regardless of the fact that the shorter side is in the weft or the warp direction of the fabric.

6. Protective element according to claim 1, characterized in that the shorter side of the meshes (11) ranges from 5 to 150 μm.

7. Protective element according to claim 1, characterized in that said fabric is a monofilament fabric, the monofilament having a diameter in the range from 10 to 90 μm.

8. Protective element according to claim 7, characterized in that said fabric is manufactured with threads made of a synthetic technopolymer belonging to the family consisting of polyesters, polyamides, polyaryletherketones, polyparaphenylene sulphide, polypropylenes, perfluorocarbons, polyurethanes, or polyvinyl chlorides.

9. Protective element according to claim 7, characterized in that said fabric is manufactured with threads made of an artificial polymer belonging to the family consisting of cellulose or viscose.

10. Protective element according to claim 8, characterized in that the aforementioned fabric is coated with a hydrophobic or hydro/oleophobic coating.

11. Protective element according to claim 1, wherein the size of said meshes is variable in one or both the weft and warp directions.

12. Protective element according to claim 11, characterized in that it provides yarns having different nature and/or different size, either in the same direction, or in the different weft and warp directions.

13. Acoustic component of consumer electronic devices, characterized in that it consists of a micro-speaker for smartphone, tablet and the like provided with at least one protective element according to claim 1.

14. Use of a fabric for protection filters of acoustic components of electronic devices, characterized in that it is a fabric (25) with open meshes (11) having rectangular shape and being made of a synthetic monofilament fabric, whose sides (12, 13) are made up by respective threads (26, 27).

15. Use according to claim 14, characterized in that said mesh (11) has an asymmetrical structure, that is diversified as to the linear density/cm of weft threads and warp threads of said mesh in the respective directions and/or diversified as to the diameter of the warp threads and for the diameter of the weft threads of the mesh (11) itself.

16. Use according to claim 15, characterized in that said meshes (11) have rectangular openings, wherein the shorter side/longer side dimensional ratio is in the range between 0.3 and 0.9 regardless of the fact that the shorter side is in the weft or the warp direction of the fabric.

17. Use according to claim 16, characterized in that the shorter side of the meshes (11) ranges from 5 to 150 μm.

18. Use according to claim 15, characterized in that said fabric is a monofilament fabric, the monofilament having a diameter ranging from 10 to 90 μm.

19. Use according to claim 18, characterized in that said fabric is manufactured with threads made of a synthetic technopolymer belonging to the family consisting of polyesters, polyamides, polyaryletherketones, polyparaphenylene sulphide, polypropylenes, perfluorocarbons, polyurethanes, or polyvinyl chlorides.

20. Use according to claim 18, characterized in that said fabric is manufactured with threads made of an artificial polymer belonging to the family consisting of cellulose or viscose.

21. Use according to claim 15, characterized in that the aforementioned fabric is coated with a hydrophobic or hydro/oleophobic coating.

22. Use according to claim 15, wherein the size of said meshes is variable in one or both the weft and warp directions.

23. Use according to claim 22, characterized in that it provides yarns having different nature and/or different size, either in the same direction, or in the different weft and warp directions.

24. (canceled)
